(19) United States
(12) Patent Application Publication
(10) Pub. No.: US 2006/0026186 A1
(43) Pub. Date: Feb. 2, 2006

(54) Device and method for management of content data

(75) Inventor: Hyung-Hoon Kim, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 11/007,038

(22) Filed: Dec. 8, 2004

(30) Foreign Application Priority Data
Jul. 29, 2004 (KR) 59639/2004

(51) Int. Cl. G06F 7/00

(52) U.S. Cl. 707/101

(57) ABSTRACT

Disclosed is a device and a method for managing content data using a function to restrict data reproduction in order to prevent a user's unauthorized use or abuse of the content data according to a content data provider's intention. In order to restrict the reproduction of downloaded content data, additional data that defines conditions for the data reproduction is added to the downloaded content data. The content data including the additional data is stored in a memory of the user's terminal. When the content data is reproduced, reproducing option values concerning restricted reproduction conditions of the content data is extracted from the additional data to control and restrict the reproduction of the content data. Variables are set to enable the user to reproduce a downloaded content data file only up to a limited number of times for a limited period of time.

### PRIORITY

This application claims priority to an application entitled “Device and Method for Management of Content Data” filed with the Korean Intellectual Property Office on Jul. 29, 2004 and assigned Ser. No. 2004-59639, the contents of which are hereby incorporated by reference.

### BACKGROUND OF THE INVENTION

1. Field of the Invention

The present invention relates to a method for management of content data, and more particularly, to a device and a method for managing content data to prevent any unauthorized use or abuse of the content data when downloaded to a mobile terminal.

2. Description of the Related Art

With the development of high-performance mobile terminals having high picture quality, graphics and multimedia functions, the demand for large-capacity memories is increasing. Recent technological developments in the mobile communication environment have enabled data transmission between servers and mobile terminals through wire-line and/or wireless networks. Accordingly, users can download necessary data to mobile terminals in order to use various content data services.

Downloaded data, such as MP3 data, is compressed to save memory space. Compressed content data is stored in a flash memory of a mobile terminal for nonvolatile storage. While hard drives and flash memory are nonvolatile memories, flash memory, unlike a hard drive, offers fast access and reduced power consumption. Accordingly, the flash memory is generally used in small and memory limited applications such as embedded systems and mobile terminals.

The storage of content data in a flash memory is accomplished in the following manner. A content data provider (i.e. a server) provides clients with content data, such as MP3 audio data, through wire-line or wireless networks. A client can download necessary content data from the server and store the downloaded data in a predetermined download directory within a flash memory. At this time, the content data is stored in its entirety in the download directory regardless of the information about reproduction condition information which is added to the content data.

Hereinafter, a process of reproducing content data stored in a mobile terminal with a media player (for example, an MP3 player) function will be explained. A mobile terminal can reproduce music using audio data compression and coding algorithms available through an MP3 player function. A data processor in the mobile terminal temporarily loads the content data stored in the flash memory to a volatile RAM buffer which offers faster access than the flash memory in order to reproduce the content data.

For the protection and management of intellectual property rights such as copyrights, content data providers limit the frequency of users' access to each content data, such as audio data, by adding reproducing condition information to each content data.

Typically, downloaded content data is stored only in a directory designated within a flash memory. In other words, all content data downloaded to a mobile terminal is stored in a single directory, regardless of different reproduction conditions of the data, such as reproducible periods and reproduction frequencies.

Content data is stored as a single file of a predefined format. Reproducing condition information for each individual file is included in a file to be reproduced and stored altogether. Accordingly, a user may change specific values in the reproducing condition information (for example, values representing a reproducible period of time and a limited frequency of reproduction) in order to use in an unauthorized manner or abuse the content data. For example, when a content data file with modified reproducing condition information is downloaded, the data can be limitlessly reproduced.

### SUMMARY OF THE INVENTION

Accordingly, the present invention has been made to solve the above-mentioned problems occurring in the prior art, and an object of the present invention is to provide a content data management device and a method for storing content data including reproducing conditions thereof to prevent any unauthorized use or abuse of the content data reproduced on a mobile terminal.

Another object of the present invention is to provide a device and a method for managing content data by allowing a user to reproduce the content data only under conditions agreed to with a content data provider and defined in reproducing condition information included in the content data.

### BRIEF DESCRIPTION OF THE DRAWINGS

The above and other objects, features and advantages of the present invention will be more apparent from the following detailed description taken in conjunction with the accompanying drawings, in which:

FIG. 1 is an illustration for explaining a process of downloading content data according to the present invention;

FIG. 2 is a block diagram of a client terminal for processing a content data file according to the present invention;

FIG. 3 illustrates the structure of a content data file downloaded according to the present invention;

FIG. 4 is a control flow chart showing the processing of a content data file according to the present invention;

FIG. 5 shows a format of additional data according to the present invention;

FIGS. 6A and 6B show the structure of each field of a memory storing a content data file according to the present invention; and

FIG. 7 is a control flow chart showing a process of reproducing data in a file management system according to the present invention.

### DETAILED DESCRIPTION OF THE PREFERRED EMBODIMENT

Hereinafter, preferred embodiments of the present invention will be described with reference to the accompanying drawings. In the following description of the present invention, a detailed description of known functions and configurations incorporated herein will be omitted when it may make the subject matter of the present invention unclear.

The present invention relates to a device and a method for managing content data using a function to restrict data reproduction in order to prevent the unauthorized use or abuse of the content data according to a content data provider's intention.

In order to restrict the reproduction of downloaded content data, additional data that defines conditions for the reproduction of the content data is added to the downloaded content data. The downloaded content data including the additional data (that defines conditions for the reproduction of the content data)is stored in the memory of the user's terminal. When the content data is reproduced, reproducing option values concerning restricted reproduction conditions of the content data, are extracted from the additional data to control and restrict the reproduction of the content data. The reproducing option values refer to data for restricting the reproduction of the content data, such as a restricted period of reproduction and a restricted number of times of reproduction. According to a preferred embodiment of the present invention, variables are also set to enable the user to reproduce a downloaded content data file only up to a limited number of times for a limited period of time. The variables are counted and compared with standard reproducing option values to determine whether the content data can be further reproduced.

Content data refers to audio data, video data such as images and moving pictures, and computer programs. For the sake of clarity, in the following description of the invention, content data will refer to audio data.

Hereinafter, transmission of content data through a communication network, such as the Internet, or through a wire-line connection to a computer will be explained.

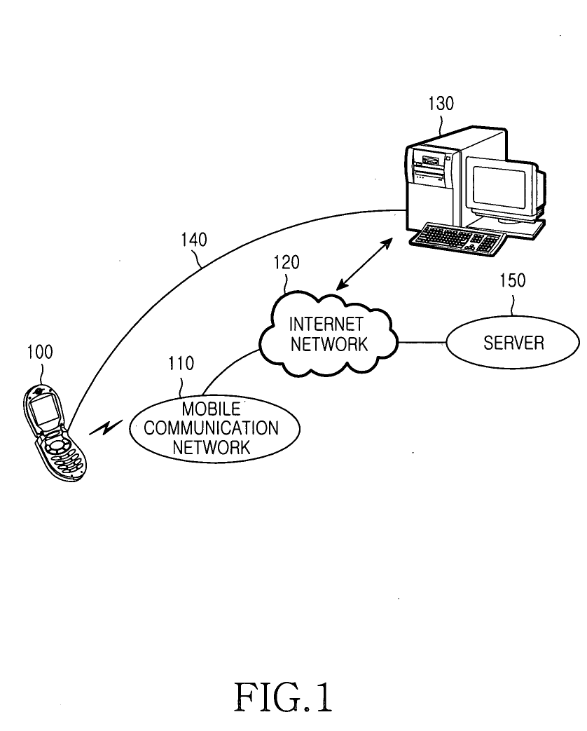

Generally, content data is downloaded from a server to a mobile terminal upon the user's demand. FIG. 1 schematically illustrates a process of downloading content data according to the present invention. A server 150 provides content data, such as audio data. A client terminal 100 is a mobile terminal (e.g., a mobile terminal or a PDA) of a content data user. The client terminal 100 is connected to an Internet network 120 through a mobile communication network 110. A computer 130, which is connected to the Internet network 120, transmits a content data file selected by the user on a content data provider system (i.e., the server 150) to the client terminal 100 through the mobile communication network 110. The data transmission is achieved through the Internet network 120. It is preferable to access the server 150 connected to the Internet network 120 through the personal computer 130 or the client terminal 100 connected to the mobile communication network 110.

Since the client terminal 100 is connected to the computer 130 by a wire-line 140, it may directly download content data stored in the computer 130. At this time, the server 150 provides the content data in form of a file to the client terminal 100.

In order for the client terminal 100 to receive content data from the server 150, a format should be predefined to identify whether the content data downloaded to the client terminal 100 has a reproduction restrictive feature. The server 150 converts the content data into a predefined format to be transmitted in response to the request from the client terminal 100.

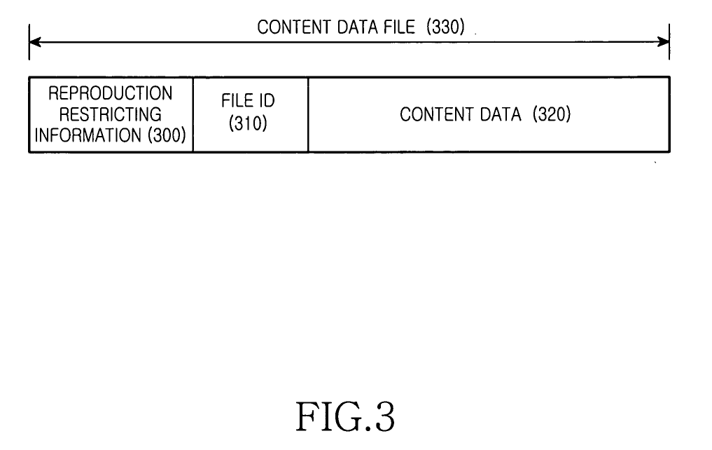

FIG. 3 shows the format of a content data file downloaded to the client terminal 100 according to the present invention.

Referring to FIG. 3, the server 150 transmits a content data file 330 with reproducing condition information added to content data 320 in order to inform the client terminal 100 of the features of the transmitted file 330. The reproducing condition information added to the content data 320 includes a file ID 310 and reproduction restricting information 300 showing whether the content data 320 has a reproduction restrictive feature.

The file ID 310 is a unique identification code assigned to each content data file 330 generated in response to the user's demand to download. Every content data file 330 has its own file ID. The file ID 310 is included in the content data file 330 which is transmitted to the client terminal 100.

As explained above, the server 150 provides the client terminal 100 with the content data file 330 including the reproduction restricting information 300, file ID 310 and content data 320.

When downloading the content data file 330, the client terminal 100 reads the predefined format to determine whether the reproduction of the content data is restricted. More specifically, the client terminal 100 analyzes the reproduction restricting information 300 included as a reproduction condition in the content data file 330 as shown in FIG. 3. The client terminal 100 classifies downloaded content data files according to corresponding reproduction restricting information and stores the classified files in different directories of the memory.

In other words, the client terminal 100 downloads and saves content data files in different directories according to their reproduction restricting information 300. There are two types of directories which are used to save the downloaded content data files. One type of directory is a directory which is used for storing reproduction restrictive content data files, while the other is a directory for storing non-restrictive content data files (i.e., limitlessly reproducible content data files).

The client terminal 100 reads the reproduction restricting information 300 included in a downloaded content data file and stores the downloaded content data file in the appropriate directory. More specifically, the client terminal 100 detects a flag value which is set in the reproduction restricting information 300 in order to select an appropriate directory. If the flag value in the reproduction restricting information 300 is zero, the client terminal 100 will determine that the downloaded content data file is limitlessly reproducible. If the flag value is 1, the client terminal 100 will determine that the reproduction of the downloaded file is restrictive.

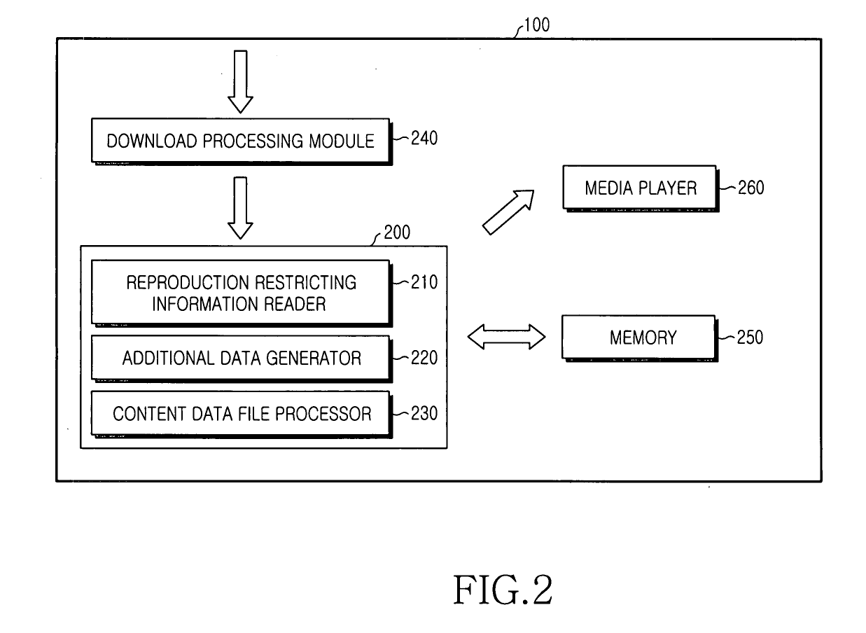

The above download process will be explained in more detail with reference to FIGS. 2 and 3. FIG. 2 is a block diagram of the client terminal 100 for processing a content data file according to the present invention.

When the user (e.g., the client terminal 100) requests the server 150 to provide content data, the server 150 sends a content data file 330 generated by adding reproduction restricting information to the requested content data in response to the user's request. The client terminal 100 can then download the content data file 330 through the aforementioned path using a download processing module 240 mounted therein.

The downloaded content data file 330 is processed by a file management system 200 provided in the client terminal 100. The processed content data file 330 is stored in a predetermined area of the memory. The predetermined area refers to one of the two directories classified according to the restrictive or non-restrictive features of downloaded content data files. It is also possible to physically and/or virtually divide the memory into a plurality of areas to store downloaded content data files.

As a means for detecting the features of the content data file 330, a reproduction restricting information reader 210 is provided within the file management system 200. According to a preferred embodiment of the present invention, the file management system 200 analyzes the reproduction restricting information 300 included in the content data file 330. More specifically, the reproduction restricting information reader 210 in the file management system 200 detects a value (e.g., a flag value in the reproduction restricting information 300) set to identify whether the downloaded content data file 330 is limitlessly reproducible.

For example, if a flag value is detected in the reproduction restricting information 300, the content data file 330 will be stored in a reproduction restrictive directory. If no flag value is detected (i.e. if a default value 0 is detected), the content data file 330 will be stored in a reproduction non-restrictive directory. The two directories are included in the memory 250 using a flash memory according to the present invention.

In the embodiment as explained above, when downloading the content data file 330, the client terminal 100 first analyzes the reproduction restricting information 300 included in the content data file 330 and then stores the content data file 330 in a corresponding directory based on the results of analysis.

According to another embodiment of the present invention, it is possible to first download the content data file 330 into one of the two directories and then analyze the reproduction restricting information 300 included in the content data file 330.

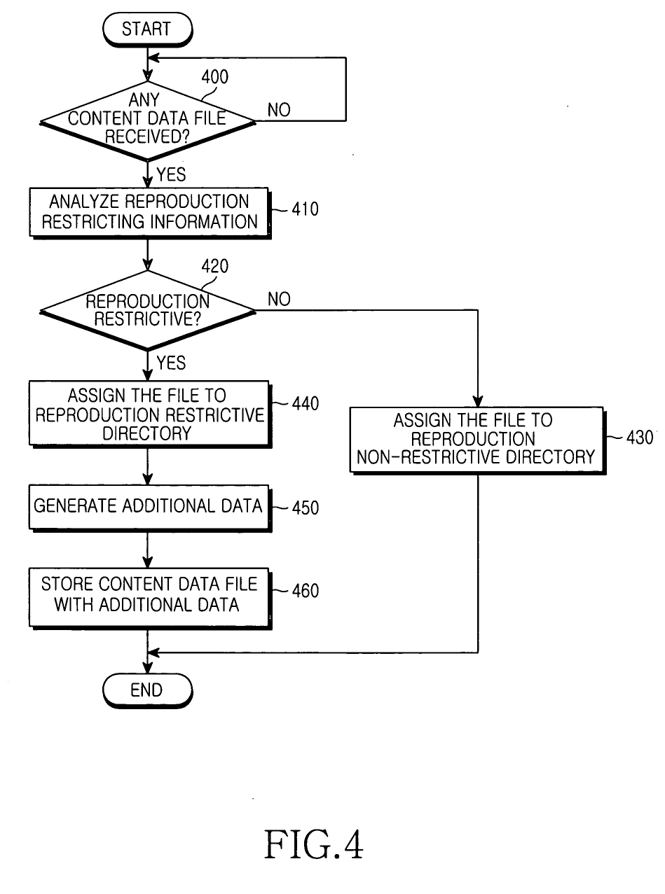

In the following description of the present invention, it is assumed that all content data files downloaded from the server are stored in the reproduction restrictive directory. A process of storing the content data files will be explained in detail with reference to the flow chart of FIG. 4.

Referring to FIG. 4, the client terminal 100 determines whether any content data file has been received from the server 150 at step 400. Since every downloaded content data file is processed by the file management system 200 within the client terminal 100, the file management system 200 will be mentioned hereinafter, instead of the client terminal 100.

When a content data file is received, the file management system 200 analyzes the reproduction restricting information included in the content data file at step 410. Subsequently, at step 420, the file management system 200 detects whether a flag value representing the restriction of data reproduction is set in the reproduction restricting information. If a flag value is not detected, the file management system 200 determines that the received content data file is limitlessly reproducible and will proceed with step 430. At step 430, the file management system 200 assigns the content data file to the reproduction non-restrictive directory and will perform a typical storage process.

If a flag value representing the restriction of data reproduction is detected at step 420, the file management system 200 will recognize that the reproduction of the content data file is restrictive and will proceed with step 440. At step 440, the file management system 200 will assign the content data file to the reproduction restrictive directory.

At step 450, the file management system 200 generates additional data to store the content data file. At step 460, the file management system 200 includes the generated additional data in the content data file and stores the content data file with the additional data in the reproduction restrictive directory which is allocated in the flash memory. The additional data is generated by an additional data generator 220 provided in the file management system 200.

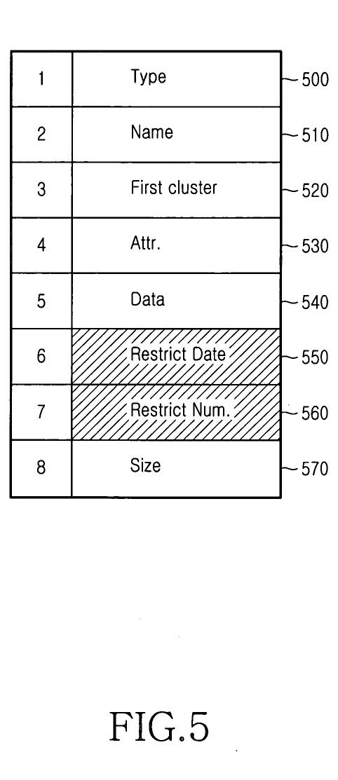

The additional data generated and stored as part of the content data file has a format as shown in FIG. 5.

Referring to FIG. 5, the additional data includes Type 500 representing a file type (e.g., an MP3 file type), Name 510 representing a file name, First Cluster 520 representing a file storage location, Attr. 530 representing reading/writing features of a file, Date 540 representing the date of a file download or an additional data generation, Restrict Date 550 representing a restricted period of reproduction, Restrict Num. 560 representing a restricted number of times of reproduction and Size 570 representing a file size.

The Restrict Date 550 and the Restrict Num. 560 are generated in the client terminal 100 when storing the downloaded content data file in order to prevent any unauthorized use or abuse of the content data file.

An agreement between the content data provider and the mobile service provider of the client terminal 100 defines the period and frequency of reproduction so that the client terminal 100 can reproduce a stored content data file only up to the predefined number of times for the predefined period. The content data provider and the mobile service provider select a restricted period of reproduction and a restricted number of reproductions for each content data as standard reproducing option values.

In other words, agreed period and number of reproductions are set as standard reproducing option values for each content data file and stored in the flash memory according to the additional data format as shown in FIG. 5. The client terminal 100 has standard reproducing option values at the time of manufacture. The standard reproducing option values are inserted in the additional data format when any content data file is stored.

The user may download a content data file, changing the restricted period of reproduction and the restricted number of reproductions in an unauthorized attempt to abuse or limitlessly reproduce the content data file. However, the reproduction of the content data file will be restricted according to the standard reproducing option values set in a predefined format by the client terminal 100 when storing the content data file.

Particularly, variables are set to count the number of days from the date that the content data file has been downloaded and the number of times that the content data file has been actually reproduced from the date of download, thereby enabling the user to reproduce the content data file only up to the predetermined number of times and the predetermined number of days which are defined by the standard reproducing option values. The value of the counted number of days of reproduction is increased by one after lapse of one day. The value of the counted number of times of reproduction is increased by one whenever the content data file is reproduced.

When the user opens the content data file stored in the corresponding directory of the memory 250 using a media player 260 provided in the client terminal 100, the file management system 200 increases the value of the number of days of reproduction by the corresponding number of days which have passed since the content data file was stored in the restrictive memory based on a timer mounted in the client terminal 100. For example, if the content data file is stored and opened (e.g., played) on the same day, then the value of the number of days of reproduction is not changed. Alternatively, if the content data file is opened after one or more days has passed since the content data file was saved, then the value of the number of days of reproduction is increased by a value which corresponds to the number of days which have lapsed since the content data file was saved. Moreover, when the user opens the content data file, the file management system increases the value of the number of times of reproduction by one.

The memory 250 stores at least one content data file, and reproducing option values including standard reproducing option values representing the reproduction conditions of each content data, and variables changing with the reproduction of each content data.

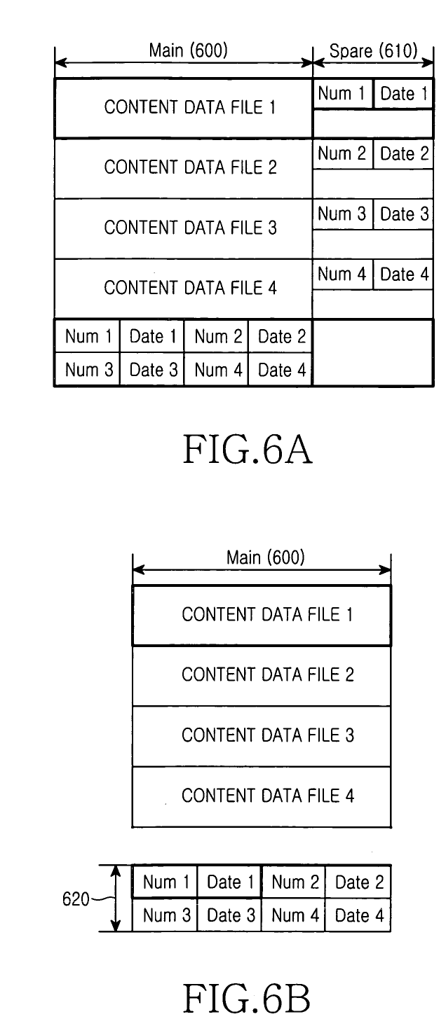

As explained above, the value of the counted number of days of reproduction is changed every day. Moreover, the value of the number of times of reproduction is increased by one every time the respective content data file is opened. The method used to store the values of the number of days of reproduction and number of times of reproduction will be described with reference to FIGS. 6A and 6B which show a structure of each field of the memory storing a content data file according to the present invention.

As shown in FIG. 6A, a main area 600 of the memory stores a content data file, while a spare area 610 stores its respective variables (i.e., number of days and number of times of reproduction). For example, a first content data file 1 is mapped with a number of times of reproduction variable (Num1) and a number of days of reproduction variable (Date1). Second to fourth content data files 2 to 4 are mapped respectively with Num2 to Num4 and Date2 to Date4 variables. The numbers of times of reproduction variables Num1 to Num 4, and the number of days of reproduction variables Date1 to Date 4, are stored in a single file in the main area 600. In this embodiment, a NAND-type flash memory is used in the client terminal 100.

FIG. 6B shows the use of an NOR-type flash memory in the client terminal 100. When NOR-type flash memory is used, the numbers of times of reproduction variables (e.g., Num1 to Num 4) and the number of days of reproduction variables (e.g., Date1 to Date 4) can be stored in a single file in the main area 600. Alternatively, the numbers of times of reproduction variables (e.g., Num1 to Num 4) and the number of days of reproduction variables (e.g., Date1 to Date 4) can be stored in a separate NOR flash memory area (extra NOR area) 620 as shown in FIG. 6, rather than in the main area 600 storing the content data files.

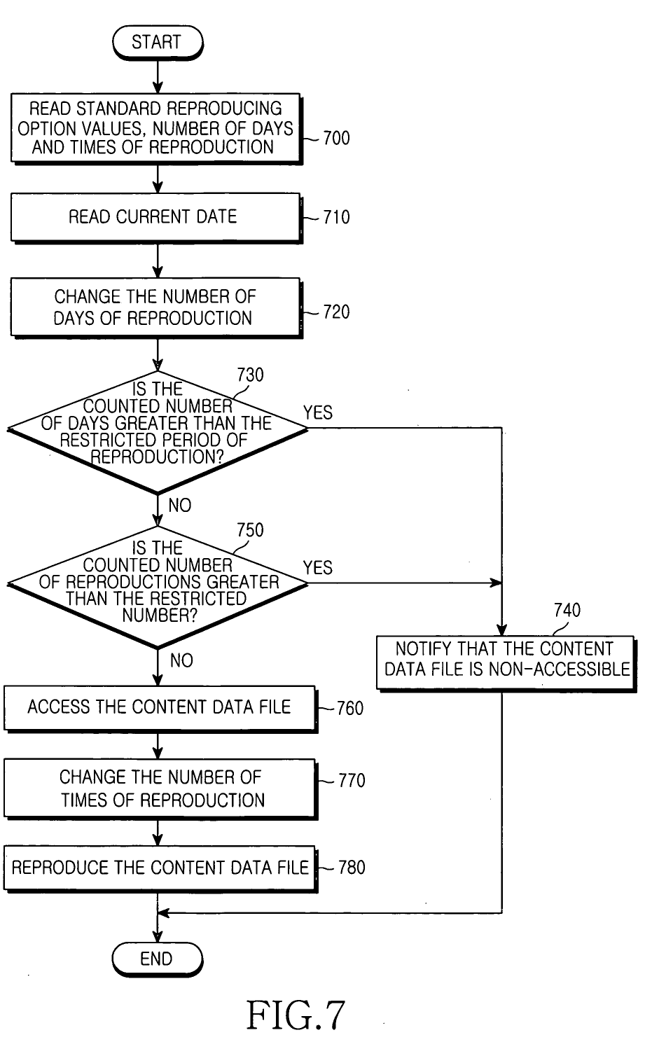

Hereinafter, a process of reproducing a content data file in the file management system 200 will be explained with reference to FIG. 7 which is a flow chart illustrating the reproduction process performed by the file management system 200 according to the present invention.

When the user inputs a command to reproduce a content data file, the client terminal 100 implements the reproduction of the desired content data file using the media player 260.

More specifically, in response to the user's demand to reproduce a content data file, the memory 250 provides the content data file to the file management system 200 which will perform the procedure as shown in FIG. 7. The content data file is processed by the content data file processor 230 in the file management system 200.

At step 700, the file management system 200 reads the standard reproducing option values preset when downloading the content data file (such as a restricted period of reproduction and a restricted number of reproductions) in order to process the received content data file. At the same time, the file management system 200 reads the variables, such as counted number of days of reproduction and number of times of reproduction (e.g., the number of times the content data file has actually been reproduced). Subsequently, the file management system 200 proceeds with step 710 to change the number of days of reproduction variable based on the current date. The changed number of days of reproduction variable is stored in the format as shown in FIG. 6.

The client terminal 100 provides information about the current date based on a RTC (Real Timer Clock) offered from the mobile communication network in order to prevent the user from modifying the current date and time. According to another embodiment of the present invention, the client terminal 100 may include a separate timer for counting the number of days of reproduction from the date a content data file is stored. The separate timer can count the days from the file storage point to the end point of reproducible period.

In order to perform the reproduction of the selected content data file through the media player 260, the file management system 200 loads and reads the content data file stored in the memory 250.

At step 730, the file management system 200 determines whether the counted number of days exceeds the restricted period of reproduction. As one of the standard reproducing option values generated during storage of the content data file, the restricted period of reproduction corresponds to reference numeral 550 (Restrict Date) in the format as shown in FIG. 5. The restricted period of reproduction is a value fixed upon agreement between the content data provider and the mobile service (client terminal) provider.

If the counted number of days is determined to exceed the restricted period at step 730, the file management system 200 will proceed with step 740 to inform the media player 260 that the content data file is no longer accessible and will stop the operation for the file reproduction. In other words, if the counted number of days exceeds the restricted period of reproduction (i.e. the reproducible period), the file management system 200 provides only a message (e.g., “reproduction period error”) to the media player 260, without providing the content data file.

Supposing that the restricted period of reproduction of a content data file is 10 days from download, the content data file cannot be reproduced from the eleventh day onward. In other words, the content data file is not reproducible if the counted number of days from download exceeds ten.

If the counted number of days is determined to be within the restricted period of reproduction at step 730, the file management system 200 will proceed with step 750 to determine whether the number of times that the content date file has been reproduced exceeds the restricted number of reproductions. If the counted number of times of reproduction is greater than the restricted number of times of reproduction, the file management system 200 will proceed with step 740 and will stop the operation for the file reproduction. On the other hand, if the counted number of times of reproduction does not exceed the restricted number of times of reproduction, the file management system 200 will proceed with step 760 to access the content data file and provide the file to the media player 260.

At step 770, the file management system 200 increases the variable representing the actual number of times of reproduction by one. In other words, the file management system 200 counts every time the content data file is reproduced and increases the number of times of reproduction variable accordingly and stores the increased variable. At step 780, the file management system 200 provides the content data file requested by the user to the media player 260 to reproduce the content date file.

In the format of additional data as shown in FIG. 5, the restricted period (Restrict Date) 540 and the restricted number of reproductions (Restrict Num) 560 can be changed by the following method.

The client terminal 100 sends the ID of a content data file to the server 150 which is the content data provider. Upon receiving the ID, the server 150 sends newly changed values representing a restricted period of reproduction (Restrict Date) and a restricted number of times of reproduction (Restrict Num) to the client 100. The client terminal 100 stores the values in a file form in the memory 250 or as general data in a predetermined area assigned in the memory 250. According to the new values, the client 100 changes the restricted period of reproduction (Restrict Date) and the restricted number of times of reproduction (Restrict Num) in the format of additional data. Based on the new values, the client terminal 100 will determine whether the content data file can be loaded and reproduced.

As explained above, when a content data file is downloaded, it is stored together with additional data including the predefined period of reproduction and the predefined number of times of reproduction of the content data file. Also, variables are set to count the number of days and number of times the content data file has actually been reproduced and restrict the reproduction of the content data file when the counted number of days of or the counted number of times of reproduction exceeds the predefined period of reproduction or number of times of reproduction, respectively. The number of days is counted based on the current date and compared with the predefined reproducible period. If the counted number of days of reproduction does not exceed the predefined period of reproduction, the content date file can be reproduced.

Also, the number of times of reproduction is counted whenever the content data file is reproduced. If the counted number of times of reproduction does not exceed the predefined number of times of reproduction, the content data file can be reproduced. According to another embodiment of the present invention, a content data file which has been reproduced over the predefined days and times can be deleted from the memory of the client terminal 100.

After downloading a content data file, the client terminal itself can define a period and a number of times the content data file is reproducible. Accordingly, the client terminal can prevent any unauthorized use or abuse of the content data file, thereby contributing the improvement of content data services.

Also, the client terminal may have a structure that enables the user to reproduce a content data file only up to a predefined number of times during the predefined period of reproduction and automatically delete the respective content data file after lapse of the predefined period of reproduction or after the predefined number of reproductions. The structure can improve the user convenience and protect the content data provider's own interests.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A content data management device for storing and managing content data, comprising:
a memory for storing at least one content data, standard reproducing option values representing reproduction conditions of each content data, and variables which change with the reproduction of each content data; and
a file management system for calculating the variables when reproducing content data and comparing the variables with the standard reproducing option values to determine whether the content data is further reproducible.

2. The content data management device as claimed in claim 1, wherein said memory includes:
a main area for storing a plurality of content data and standard reproducing option values representing reproduction conditions of each content data; and
a spare area for storing variables which change with the reproduction of each content data stored in the main area.

3. The content data management device as claimed in claim 1, wherein said memory includes:
a main area for storing a plurality of content data and standard reproducing option values representing reproduction conditions of each content data; and
an extra area for storing variables which change with the reproduction of each content data stored in the main area.

4. The content data management device as claimed in claim 1, wherein said standard reproducing option values are generated when content data downloaded from a content data providing server is stored.

5. The content data management device as claimed in claim 1, wherein said standard reproducing option values are predefined and stored according to an agreement between a content data providing server and a mobile service provider.

6. The content data management device as claimed in claim 1, wherein said standard reproducing option values include at least one of a restricted period of reproduction and a restricted number of reproductions.

7. The content data management device as claimed in claim 1, wherein said variables include at least one of a number of days the content data has actually been reproduced and a number of times the content data has actually been reproduced.

8. The content data management device as claimed in claim 7, wherein said number of days the content data has actually been reproduced is determined based on a comparison with an output of an RTC (Real Timer Clock).

9. The content data management device as claimed in claim 1, wherein said content data is transmitted in response to a request by a user accessing a content data providing server after the content data is converted into a predetermined distinguishable format.

10. The content data management device as claimed in claim 9, wherein said predetermined distinguishable format includes reproduction restricting information, a file ID and content data.

11. The content data management device as claimed in claim 10, wherein said file management system classifies received content data according to the reproduction restricting information included in the predetermined distinguishable format and stores the classified content data in the memory.

12. The content data management device as claimed in claim 10, wherein said standard reproducing option values are updated by a process of sending a file ID included in the predetermined distinguishable format to the content data providing server from a content data management device, detecting the file ID by a content data providing server, and sending new standard reproducing option values which are determined by the content data providing server according to the detected file ID to the content data management device.

13. A method for storing and managing content data, comprising the steps of:
when receiving the content data, generating and storing standard reproducing option values representing reproduction conditions of the content data and variables which change with the reproduction of the content data;
when reproducing the content data, updating the variables and comparing the variables with the standard reproducing option values; and
determining whether the content data is further reproducible according to the results of comparison.

14. The method as claimed in claim 13, further comprising the steps of:
accessing a content data providing server and requesting the server to send the content data;
receiving the content data converted into a predetermined distinguishable format from the server; and
determining whether reproduction of the received content data is restricted based on the predetermined distinguishable format and storing the content data according to the determination.

15. The method as claimed in claim 14, wherein said content data is stored in a memory having a reproduction restrictive directory for storing reproduction restrictive content data and a reproduction non-restrictive directory for storing limitlessly reproducible content data.

16. The method as claimed in claim 15, wherein said content data, if determined to be reproduction restrictive, is stored in the reproduction restrictive directory, together with standard reproducing option values that represent reproduction conditions of the content data.

17. The method as claimed in claim 13, wherein said stored variables are compared with the standard reproducing option values included in the content data to determine whether the variables exceed the standard reproducing option values and to restrict the reproduction of said content data when the variables exceed the standard reproducing option values.

18. The method as claimed in claim 13, wherein said stored variables are updated and compared with the standard reproducing option values included in the content data in order to determine whether the content data can be reproduced, and reproducing said content data if the variables do not exceed the standard reproducing option values.
